(19) United States
(12) Patent Application Publication
(10) Pub. No.: US 2025/0342235 A1
(43) Pub. Date: Nov. 6, 2025

(54) SYSTEMS AND METHODS FACILITATING USER TO USER AUTHENTICATION AND AUTHORIZATION

(71) Applicant: AT&T Intellectual Property I, L.P., Atlanta, GA (US)

(72) Inventors: Lars Benjamin Johnson, Brooklyn, NY (US); Wei Wang, Montclair, NJ (US)

(73) Assignee: AT&T Intellectual Property I, L.P., Atlanta, GA (US)

(21) Appl. No.: 18/654,576

(22) Filed: May 3, 2024

(51) Int. Cl. G06F 21/31; G06F 21/32; G06F 21/62

(52) U.S. Cl. CPC G06F 21/316; G06F 21/32; G06F 21/6209

(57) ABSTRACT

Aspects of the subject disclosure may include, for example, transmitting a request to generate an authorization object; receiving a first confirmation that authenticates a primary user device from a service provider system; generating the authorization object that meets a predetermined standard and contains audio visual representation of a primary user associated with the primary user device; receiving a second confirmation that authenticates a matching between the authorization object and the primary user; uploading the authorization object to a storage of a trusted server; and executing an access mechanism to access the stored authorization object on the trusted server. Other embodiments are disclosed.

### FIELD OF THE DISCLOSURE

The subject disclosure relates to systems and methods facilitating user to user authentication and authorization.

### BACKGROUND

Currently used verification processes of user identification and user authorization may cause confusion and trigger false alarms. In order to resolve the confusion and false alarms, additional form of proof such as an original birth certificate, etc. may be needed, but it is inconvenient and impractical to expect users to carry such additional form of proof for the verification processes. Furthermore, performing such conventional verification processes in time-pressed emergency situations may result in more serious setbacks. A more practical process of verifying the user identification and user authorization in various different situations is highly desirable.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B illustrates an illustrative embodiment of operations of the system of FIG. 2A.

FIG. 2C depicts an illustrative embodiment of a method in accordance with various aspects described herein.

FIG. 2D depicts an illustrative embodiment of another method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for systems and methods facilitating user to user authentication and authorization. More specifically, the systems and methods enable a service provider system of wireless communication services to authenticate a primary user device and authorize a secondary user device via an object containing audio visual representation of a primary user and audio visual authorization for a secondary user by the primary user. Other embodiments are described in the subject disclosure.

One or more aspects of the subject disclosure are directed to a device including a processing system including a processor, and a memory that stores executable instructions that, when executed by the processing system, facilitate performance of operations. The operations include collecting a set of user information indicative of a user identity, a user device and a usage pattern of the user device, wherein the set of user information is collected to activate wireless communication services with the user device, wherein the user device comprises a primary user device and the primary user device is associated with a primary user; authenticating the primary user device resulting in an authentication based on the collected set of user information in response to an activation request of an authentication service session from the primary user device; upon the authentication of the primary user device, receiving an object generated by the primary user device, wherein the received object contains audio visual representation of the primary user and includes audio visual authorization for a secondary user by the primary user; receiving, from the primary user device, biometric data of the primary user; matching the received object with an ownership of the primary user device based on the collected set of user information and the biometric data; upon a confirmation of the matching between the received object and the ownership of the primary user device, storing the received object as a file in a storage; and generating and transmitting an access mechanism to a stored file to the primary user device.

One or more aspects of the subject disclosure are directed to a non-transitory machine-readable medium including executable instructions that, when executed by a processing system of a user device including a processor, facilitate performance of operations. The operations include transmitting a request to generate an authorization object; receiving a first confirmation that authenticates a user device of a primary user from a service provider system based on at least a set of user information, wherein the set of user information indicative of a user identity, a user device and a usage pattern of the user device is stored in the service provider system to activate wireless communication services with the user device; upon receiving the first confirmation, generating the authorization object that meets a predetermined standard and contains audio visual representation of the primary user; receiving a second confirmation that authenticates the authorization object by using a matching between the authorization object and the primary user; upon receiving the second confirmation, uploading the authorization object to a storage of a trusted server; and executing an access mechanism to access a stored authorization object on the trusted server.

One or more aspects of the subject disclosure is directed to a method including collecting, by a processing system including a processor, a set of user information indicative of a primary user identity, a primary user device and a usage pattern of the primary user device, wherein the set of user information is collected to activate wireless communication services with the primary user device; authenticating, by the processing system, the primary user device based on the collected set of user information in response to an activation request of an authentication service session from the primary user device; upon the authentication of the primary user device, receiving, by the processing system, an object generated by the primary user device, wherein the received object contains audio visual representation of a primary user and includes audio visual authorization for a secondary user by the primary user; receiving, by the processing system, biometric data that authenticate the primary user; matching, by the processing system, the received object with an ownership of the primary user device based on the collected set of user information and the biometric data; upon a confirmation of the matching, storing, by the processing system, the received object as a file in a storage; and generating and transmitting, by the processing system, an access mechanism to a stored file to the primary user.

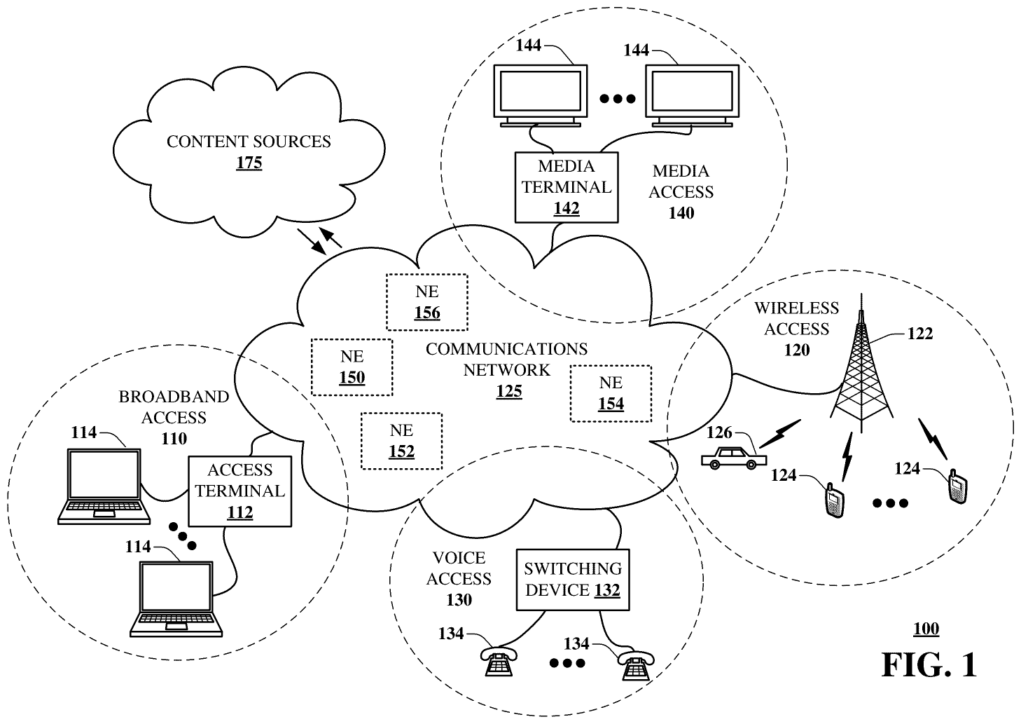

Referring now to FIG. 1, a block diagram is shown illustrating an example, non-limiting embodiment of a system 100 in accordance with various aspects described herein. For example, system 100 can facilitate in whole or in part systems and methods facilitating user to user authentication and authorization. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VOIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

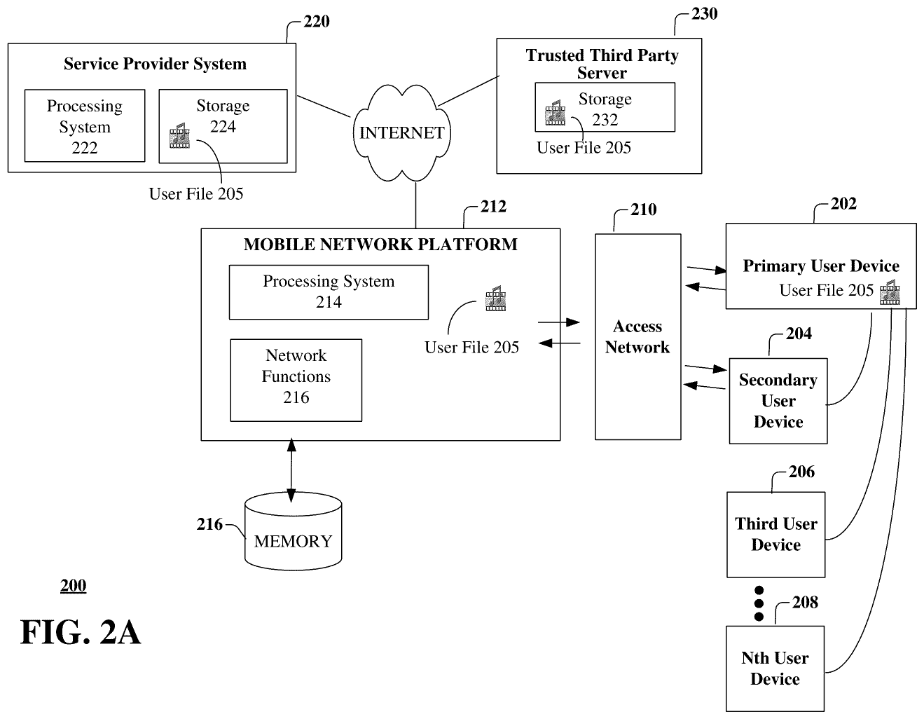

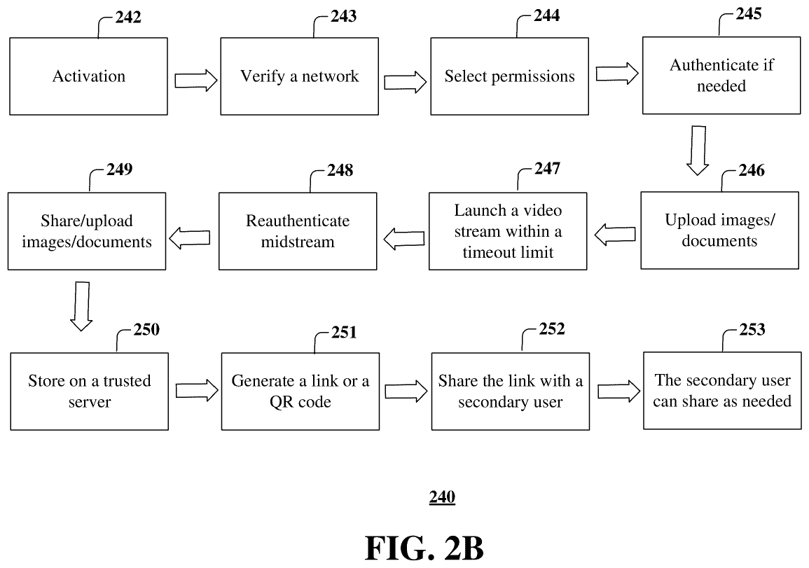

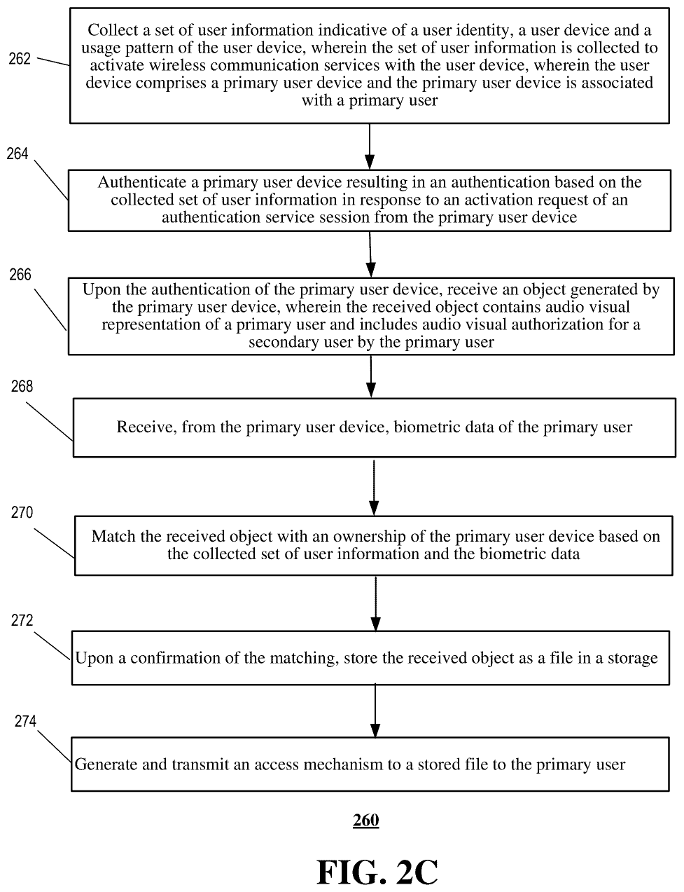

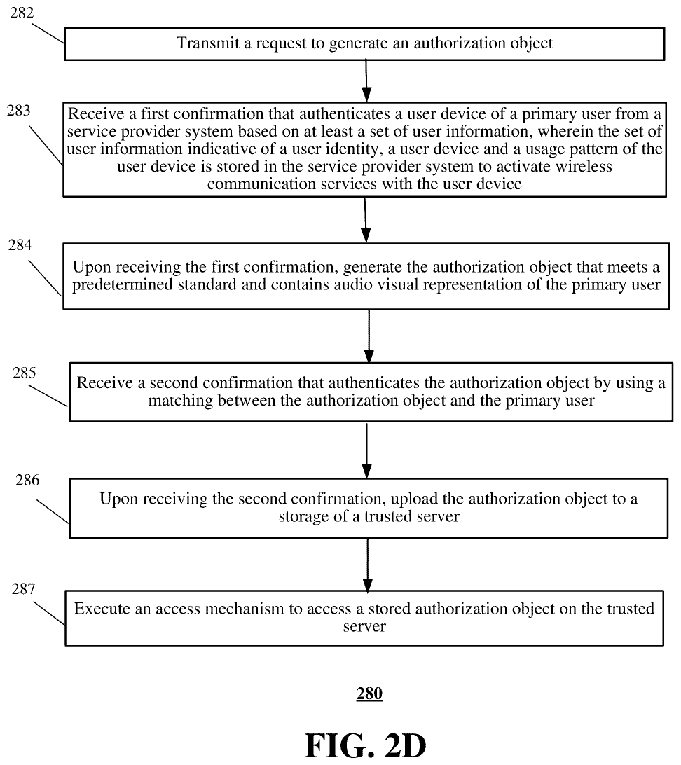

FIG. 2A is a block diagram illustrating an example, non-limiting embodiment of a system 200 functioning within the communication network of FIG. 1 in accordance with various aspects described herein. The system 200 facilitates user to user authentication and authorization in various different situations. In various embodiments, the system 200 includes a primary user device 202, a secondary user device 204, a third user device 206, and a Nth user device 208. The primary user device 202 is owned by a primary user and the secondary user device 204, the third user device 206 and the Nth user device 208 belong to a group of users who are not the primary user. In certain embodiments, the group of users can be referred to as an entourage of the primary user who are related to the primary user in a private setting (e.g., family members), a business setting (e.g., coworkers, a nanny, etc.). For instance, the primary user device 202 is owned by a holder of a mobile service account and the secondary user device 204, the third user device 206 and the Nth user device 208 are owned by family members of the primary user of the mobile service account. By way of example, the primary user is a father of a child and a secondary user of the secondary user device 204 is a mother who is travelling with the child having a different last name. A third user of the third user device 206 is a nanny who may need to make certain decisions for a child in an emergency situation while parents of the child are on the way. A friend or an extended family member can be a Nth user of the Nth user device 208. As another example, the group of users may have business relationship with the primary user.

In various embodiments, the primary user device 202 and the devices 204, 206 and 208 of the group of users are connected to a mobile network platform 212 via an access network 210. The mobile network platform 212 implements network functions of cellular communications according to various standards, e.g., 4G, 5G, 6G or higher standards. The mobile network platform 212 is connected to a memory 216 which stores instructions, software and/or applications as needed. The user devices 202, 204, 206 and 208 are communicatively connected to a service provider system 220 and/or a trusted third party server 230 via the Internet.

In various embodiments, the service provider system 220 includes a processing system 222 and a storage 224. The trusted third party server 230 includes a storage 232 and necessary processing systems (not shown). As depicted in FIG. 2A, a user file 205 may be generated by the primary user device 202 and transmitted, via the access network 210 and the mobile network platform 212, to the service provider system 220 and/or the trusted third party server 230 through the Internet. As one example, the user file 205 may include an authorization object that contains audio visual representation of a primary user. As another example, the user file 205 may include an object that contains audio visual authorization for a secondary user by the primary user. As further another example, the user file 205 includes a video stream generated by the primary user. Additionally, or alternatively, the user file 205 meets a predetermined standard, such as a duration, a format, a certain version of application, etc. The user file 205 further includes a digital fingerprint of the primary user device 202 to ensure that the user file 205 is generated by using the primary user device 202. In certain embodiments, the blockchain technologies can be used to generate the user file 205. For instance, the blockchain technologies can be used to maintain preferences of the primary user to be tracked to their own use. This can be used to an aspect of “what,” or include smart contracts around “how” and “when” and who can access the information.

In various embodiments, the primary user device 202 has its own digital fingerprint. By way of example, the primary user device 202 includes a camera and a recording done by the camera of the primary user device 202 requires the primary user's permission. For instance, the user file 205 includes a video recording of the primary user which has been performed by using the primary user device 202. In that case, the video recording of the primary user is attached with a digital fingerprint of the primary user device 202 and authentic based on the permission by the primary user.

In various embodiments, service providers/network providers have unique access to different data of users or subscribers in order to provide and activate wireless communication network services for users or subscribers. With the new 5G networks having rolled out across the country, service providers may be able to authenticate users based on network connectivity and provide accurate locations of users. Service providers may store those user data over time to generate an authentication matrix which can be used to provide a high level of trust about a user in any content, such as audio visual representation of users or subscribers by way of example only. Such user data are closely tied to use of the primary user device 202 and can serve as a platform that authenticates the primary user and a secondary user and enables the primary user or the secondary user to prove authorization given by the primary user to the secondary user.

In various embodiments, the blockchain technologies can be used to store the user file 205 in the storage 224 and the storage 232. For instance, the user file 205 is processed with blockchain hash functions and can be stored in the trusted third party server as information in the user file 205 can be sensitive and personal. The blockchain hash functions provide a digitized fingerprint of a document or set of data and can verify that information contained in the user file 205 has not been tampered with or changed in any way. The blockchain hash function may operate to compare an input block of data with a previously generated hash value. Additionally or alternatively, access to the user file 205 or one time passcodes related to the user file 205 (such as for authorization) may be managed by using the blockchain technologies.

FIG. 2B depicts an illustrative operations of the system 200 of FIG. 2A. In various embodiments, many use cases are available for the system 200. As a first use case, a secondary user (e.g., an owner of the secondary user device 204) associated with an account of the primary user, who is a primary service account holder, desires to switch to an unlimited data plan. In that case, a service provider will need to verify, with the main account holder, whether to proceed with the transaction or not. As a second use case, a parent traveling internationally with a child, may need to prove that the travel has been authorized by another parent or a legal guardian. For instance, flight crews may be trained to look for child trafficking victims, and false alarms may result in significant consequences on people involved in such events. In that case, having proof in the form of a notarized birth certificate and a letter from another parent or the legal guardian who is not present would have been enough to clear any suspicion or concern in any situation, but it is not practical to expect additional proof to be presented all the time and/or by default. As a third use case, when a child gets hurt at a playground with a caretaker, such as a nanny, or grandparents, the caretaker may need to proof of authentication and authorization by a primary user who includes a parent or a legal guardian.

As a fourth use case, an extended family member, e.g., a grandfather is not an authorized user on the main service account, but the extended family member may have a line on the main service account. The extended family member may need urgent services as his or her service is abruptly discontinued and the primary user will need to be present to verify the identity to allow the extended family member to activate his or her service. An additional use case would be around prevention of false positives in subscriber identity module (SIM) swap fraud.

In various embodiments, if the primary user has opted in to allow the service provider to track and verify the primary user, then the primary user can create a set of files that would enable the primary user or a group of users such as the secondary user, the third user, etc. to authenticate them and prove authorization given by the primary user to the group of users by using access to the set of files. For example, the primary user can provide a last known location of the primary user device (204), a video of likeness recorded on the primary user device 202 at a previous time when it was within the normal range, or identify other people who could verify the primary user accurately. This can be useful when a device and a wallet of the primary user are both stolen.

As depicted in FIG. 2B, the system 200 performs a series of acts aimed at using a unique knowledge base of service providers and facilitating users or subscribers to present proof of identity. In various embodiments, the proof of identity includes a content generated by the primary user with his or her own device and which provides specific identification of a group of users authorized by the primary user and specific permission or authorization needed to perform or complete certain tasks.

In various embodiments, the series of acts begin with activating an authentication and authorization session (Act 242). As one example, the activation involves opening a mobile application on the primary user device 202. Then the series of acts include, using a network (if desired/applicable), identify the primary user device 202 (Act 243). As described above, a service provider of the network may have access to a set of information about the primary user device 202 which is necessary to provide wireless communication services, such as an account owner, line owner(s), an identification of the primary user device 202 (e.g., International Mobile Equipment Identifier (IMEI)), SIM card information, a duration of how long the primary user device 202 has remained unchanged on the network, etc. Accordingly, the primary user device 202 can be verified using the network and during this process, the primary user can authenticate the primary user device 202 using the network. In certain embodiments, the primary user can authenticate the primary user device using a face ID, a touch ID, an unlock code, etc.

At the beginning of the process, users will be authenticated to use the service to prove that “you are a person who you claim is.” For instance, the primary user may be prompted to select or opt in this authentication service or option. Depending on a user opt-in preference, the primary user can use a face ID, a touch ID, a password, etc. to the primary user device 202 as mechanisms to prove authenticity of the primary user and primary user device. At the same time, mobility service providers can use their unique knowledge base of user devices connected to the networks, to authenticate that user devices are indeed belong to users using user devices and similar information. This may encompass “who,” “where,” and “when,” and be checking out on users' regular patterns of using their user devices.

In various embodiments, the series of acts further include selecting permissions for a current session (Act 244) and authenticating based on those permissions (Act 245). The primary user can define what he or she desires to do or achieve for the current session. For instance, the primary user can determine how to prove the identity, form of proof to verify the identity, a group of users who the primary user desires to define as an entourage, extent and content of information to be shared with the entourage, etc. The permissions may need to be set to define an entourage of the primary user, i.e., who can have access to information or content created by the primary user. By way of example, the permissions may define that the entourage is intended for a specific person, any person in an authority position (e.g., a police officer, a TSA agent at the airport, etc.), first responders, etc. First responders may find themselves in situations where they need to prove their credentials and having access to their devices, on a prioritized network service. With their stored credentials on a prioritized network, first responders can share the information they need to with authorities who are already on the scene.

Additionally or alternatively, first responders using the prioritized network may need to get permission from a parent or guardian of an individual before preforming non-critical measures. Being able to provide a signed method for the guardian to consent before treatment may alleviate some of the pressure that first responders may find themselves confronted with.

In various embodiments, the primary user device 202, which is authenticated, may be stolen or lost. A malicious actor who possesses the primary user device 202 may attempt to do user authentication and authorization using the system 200. As described above, the service providers access regular use patterns of the primary user device 202 and location information. There may be several failed attempts by a malicious actor to sign in the primary user device. Under such circumstances, authentication is requested again to verify the primary user (Act 245). Additionally or alternatively, several factors collectively can point to a determination that the primary user device 202 is not in the hand of the primary user and a message or notification ending the authentication process can be pushed (Act 245).

In various embodiments, the primary user upload images, documents, etc. that proves the identity or authority of the primary user (Act 246). For instance, the images and documents can include a birth certificate, a driver's license, and other supporting materials for the current session as needed. Additionally, the primary user may upload and share a letter which identifies an entourage to have been authorized to perform certain tasks on behalf of the primary user. By way of example, the primary user may upload a letter that authorizes a spouse to travel with their child internationally.

In various embodiments, the system 200 generates a content that authenticates and authorizes users or relevant parties, for example, an authenticated video, in various use cases described above (Act 247). As one example, the primary user such as a main service account holder, a parent, a legal guardian, caretakers, e.g., grandparents, a nanny, etc. can be easily identified without additional form of proof such as a birth certificate, being physically present at a certain location or time, and/or with stolen devices and stolen identity. Additionally, the primary user can provide legally binding permissions to another individual over the network with all of validation checks in place, as will be described in detail below in connection with FIG. 2B.

By way of example, the primary user creates and launch a video stream within a timeout limit (Act 247). The primary user may include visual or verbal confirmations in the video stream. The primary user may select and choose content of the video stream in the form of permissions. Using the example above, the content of the video stream includes permission to a spouse to travel with their child. With respect to the video stream, a spouse or an authority can see what has been authorized and proven depending on an authentication level of ownership.

In various embodiments, face matching or voice matching can be performed against the primary user appearing in the video stream (Act 248). Previously stored data for the primary user, which is stored on a server, or data pulled from a facial recognition program available at authorities can be used to perform the face matching or voice matching.

For instance, the video stream would allow the user to provide verbal and visual statements, such as authorizations to an authority, upload images and documents, and re-authenticate on the server midstream (Act 248). The video stream should be aligned with a device ownership and it is checked whether the video stream of the primary user has been created by the primary user device 202. As described above, authentication of the primary user device 202 has been completed and reauthentication midstream follows (Act 248). By way of example only, in the middle of the video streaming process, if any condition changes, for example, the primary user pulls out a more critical document to authenticate, i.e., a birth certificate, the system 200 may prompt reauthentication right after the user uses the birth certificate to make sure that the video stream is continuously secured. Another example of change is adding another person into the process. In this case, the primary user may need to be authenticated in a similar matter. In other words, when uploading a whole session with video and supporting documents to the trusted party server, it may need authentication one more time to ensure the primary user who recorded the session is the same as the user who is attempting to upload the session.

In various embodiments, content or information created by the primary user may be subject to certain requirements. For instance, a face of the primary user or a voice of the primary user should appear for face matching or voice matching. As another example, the primary user should first provide answers to secret questions prior to progressing to a next step. By way of example only, the content or information created by the primary user may take a narrative from, “trust me, my spouse is ok with me traveling with my child,” to “AT&T has verified that Jane Doe, from her own phone, with biometric authentication, uploaded a birth certificate naming Jane and John both as parents, and she gave verbal consent to John Doe taking their child out of the country.”

If visual authentication may fail, a prompt for the touch ID or other biometric authentication will be presented to the primary user within a predetermined time frame. If the prompt is not properly and timely responded, the current session will fail. If any of the checking fails, the user might be prompted for higher levels of authentication.

Data created and relevant to the current session would be shared and stored on the service provider system 220 and/or the trusted third party server 230 along with metadata supporting the identity of the primary user (Acts 249 and 250).

In various embodiments, the stored file would be accessible by a link which the primary user can share with the entourage, via a QR code, or other short codes (Act 251). The link would then be shared with other interested parties. The permission needed to view the stored content or information may include a login, a priority user authorization (e.g., FIRSTNET® services), or nothing at all. The link may be shared directly or through an entourage of a primary user, a group of users authorized by a primary user, or an intermediary (in the parent traveling abroad case, the parent traveling would have the link of the parent not traveling to share with any authorities who needed it). An alternative method may include storing a hash of the file on a trusted server (e.g., the trusted third party server 230 in FIG. 2A), such that a user may prove that the file (containing the video, meta-data, and supporting documents) has not changed since it was created. Currently, there is no available service to generate a proven content or information on the fly as the system 200 operates. To the contrary, it is typically done by taking documents to a notary to verify signatures, which can become a burden especially in time sensitive cases.

In various embodiments, the system 200 uses a sequence of authentication over time as proof. Some information will be from the network (Act 243), other information from bio-information collected by the primary user device 202 (a face ID, a touch ID, etc.) (Act 245), the rest of information from the content or information recorded (Act 247).

In various embodiments, the information, data and/or video stream resulting from the current session is stored on a trusted server and the entire session can be saved as a file on the server. It is possible to remotely access the file on a remote server or local access is also available. In certain embodiments, internationally accessing the file may be prohibited due to security reasons. As described above, the current session can be saved as proof on a blockchain or similar. For instance, a hash of the session file can be recorded. The primary user may login the trusted third party server 230 to store, view or share the file.

In various embodiments, access may be defined by an authentication level. For instance, the secondary user device 204 may only get the video, the third user device 206 may also get verification, the Nth user device 208 may also get metadata such as location.

In various embodiments, the system 200 can be coordinated with public authorities or various business entities to implement as potential unified or standardized authentication/authorization processes (e.g., this form of authentication/authorization to be accepted at different authorities or entities and/or in various contexts, a sequence of process accepted as a standard sequence of authentication/authorization). The sequence of acts in FIG. 2B can be standardized in the form of smart contracts as mentioned above or it can be tied to public key infrastructure (PKI) and post quantum algorithms. If this becomes a service offering, then it can be left up to participating authorities, entities, vendors, etc. to determine their own standard offering utilizing a backend of service providers for authentication.

In various embodiments, using artificial intelligence/machine learning techniques, the system 200 can automatically learn whether the content to be authenticated is critical or not. If the content is very critical and important (e.g., a legal document such as a will, safety and health issues, criminal content, etc.), then the system 200 requires a higher level of authentication. One example is to grant another person the authority to take their kids to travel. If the content is less critical, the system 200 may require a lower level of authentication. One example is to give another person in the house the permission to add another line to their mobility account.

As described above, the system 200 can prove that authenticity of a content is generated by a user to be claimed, may not be tempered by a middle man or artificially by technologies such as deepfake techniques. The deepfake techniques can potentially digitally manipulate a media to replace one person's likeness convincingly with that of another. The system 200 may provide an effortless experience with tools that enable customers to share permission in a proven and easy manner.

FIG. 2C depicts an illustrative embodiment of a method 260 in accordance with various aspects described herein. In various embodiments, the method 260 includes collecting a set of user information indicative of a user identity, a user device and a usage pattern of the user device (Step 262). The set of user information is collected to activate wireless communication services with users (Step 262). The primary user device is associated with a primary user. The method 260 further includes authenticating a primary user device based on the collected set of user information in response to an activation request of an authentication service session from the primary user device (Step 264). The method 260 also includes, upon the authentication of the primary user device, receiving an object generated by the primary user device, wherein the received object contains audio visual representation of a primary user and includes audio visual authorization for a secondary user by the primary user (Step 266). The method 260 includes receiving biometric data that authenticate the primary user (Step 268), matching the received object with an ownership of the primary user device based on the collected set of user information and the biometric data (Step 270), and upon a confirmation of the matching, storing the received object as a file in a storage (Step 272). The method 260 includes generating and transmitting an access mechanism to the stored file to the primary user (Step 274).

In various embodiments, the method 260 further includes receiving, from the primary user, a permission to use the set of user information for the authentication service session. The method 260 further includes, upon the authentication of the primary user device, enabling the primary user to upload an additional form of proof related to the generated object. The method 260 further includes applying a blockchain hash function to the stored file to prevent tampering or a change to the stored file. The method 260 further includes receiving a biometric proof from the primary user device when an authentication check is needed; and terminating the authentication service session upon failure of the authentication check.

In various embodiments, the method 260 further includes checking a digital fingerprint and metadata relating to the primary user device attached to the received object. The method 260 further includes, upon detection of anomalies, transmitting, by the processing system, an additional authentication request to the primary user device prior to a start of the authentication service session; and transmitting, by the processing system, a reauthentication request to the primary user device during the authentication service session.

In various embodiments, the receiving the object generated by the primary user device (Step 266) further includes receiving a video stream including video data and audio data of the primary user during the authentication service session. The generating the access mechanism (Step 274) further includes generating a link or a QR code to enable the primary user device to access the stored file; and transmitting the link to a secondary user device to allow the secondary user device to access the stored file. The secondary user device is associated with a secondary user.

The receiving the biometric data (Step 268) further comprises receiving a face ID, a touch ID, a password or a combination thereof to facilitate the matching between the object and the primary user. The method 260 further includes, in response to an execution of the link or inputting of the QR code from a secondary user device, enabling, by the processing system, the secondary user device to access the stored file in the storage.

FIG. 2D depicts an illustrative embodiment of another method 280 in accordance with various aspects described herein. The method 280 may be performed by a user equipment such as the primary user device 202 as depicted in FIG. 2A. The method 280 includes transmitting a request to generate an authorization object (Step 282), receiving a first confirmation that authenticates the primary user device from a service provider system based on at least a set of information (Step 283). The set of user information indicative of a user identity, a user device and a usage pattern of the user device is stored in the service provider system to activate wireless communication services with the user device (Step 283). The method 280 further includes, upon receiving the first confirmation, generating the authorization object that meets a predetermined standard and contains audio visual representation of a primary user (Step 284). The method 280 further includes receiving a second confirmation that authenticates a matching between the authorization object and the primary user (Step 285) and upon receiving the second confirmation, uploading the authorization object to a storage of a trusted server (Step 286). The method 280 also includes executing an access mechanism to access the stored authorization object on the trusted server (Step 287).

In various embodiments, the method 280 further includes transmitting the access mechanism to a secondary user device to facilitate access to the stored authorization object by the secondary user device. The secondary user device is associated with a secondary user. The method 280 further includes attaching a digital fingerprint and metadata relating to the user device to the generated authorization object. The method 280 further includes providing the service provider system with a face ID, a touch ID, a password or a combination thereof to facilitate the matching between the authorization object and the primary user.

In various embodiments, the generating the authorization object (Step 284) further comprises generating a video stream including the audio visual representation of the primary user and audio visual authorization for a secondary user by the primary user. The generating the authorization object (Step 284) further comprise generating the authorization object using blockchain smart contracts techniques. The predetermined standard further comprises a time duration and a size limit of the authorization object and the audio visual representation of the primary user enables facial and voice matching based on facial data and voice data previously provided by the primary user.

While for purposes of simplicity of explanation, the respective processes are shown and described as a series of blocks in FIGS. 2C and 2D, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

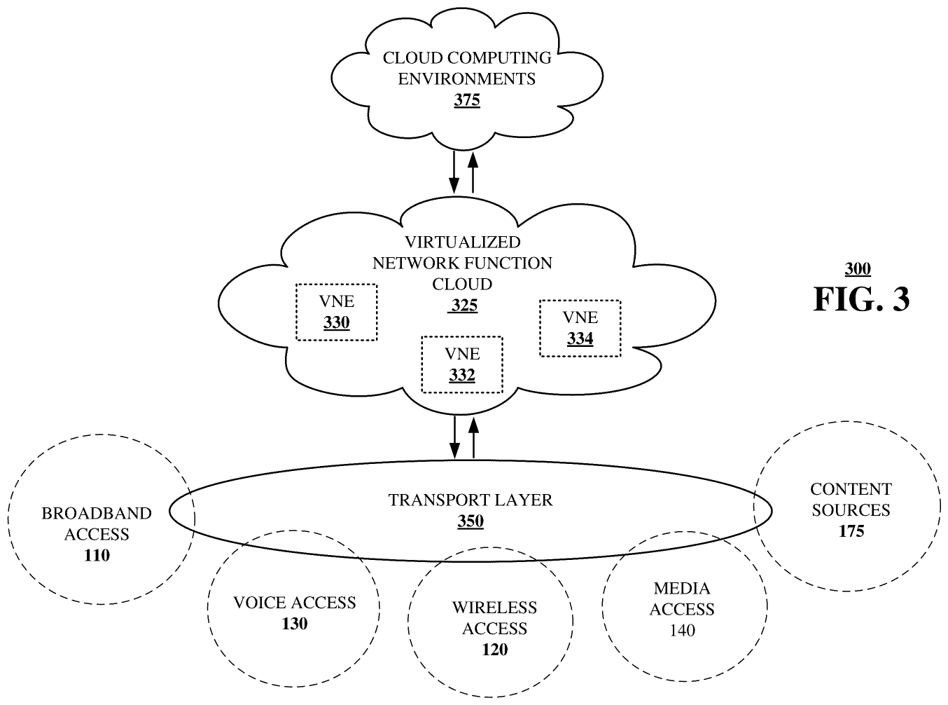

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, and method 230 presented in FIGS. 1, 2A, 2B, 2C, and 3. For example, virtualized communication network 300 can facilitate in whole or in part systems and methods facilitating user to user authentication and authorization.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers-each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

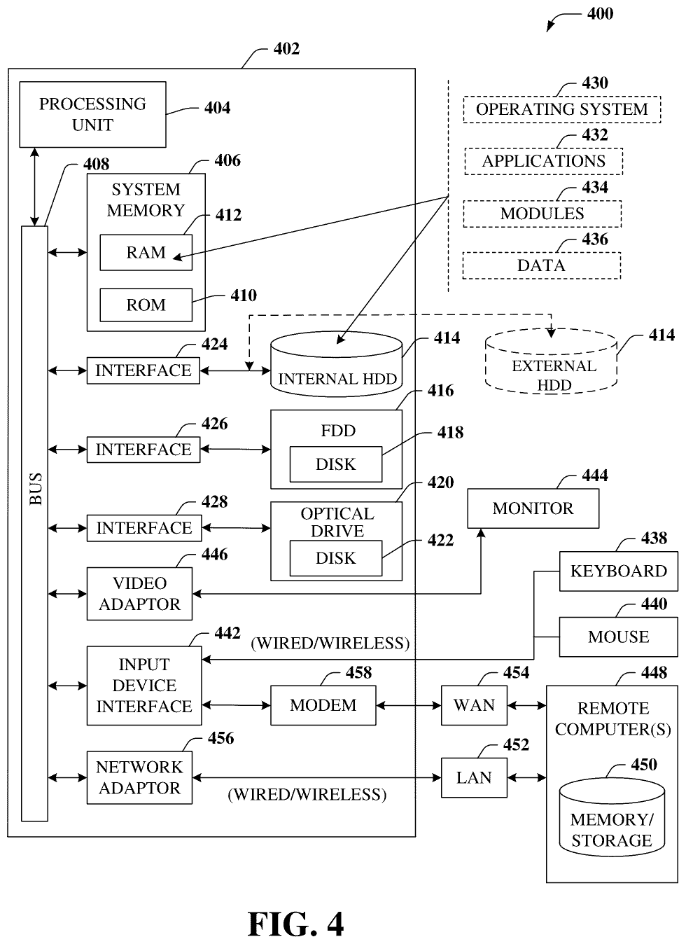

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part systems and methods facilitating user to user authentication and authorization.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM),flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

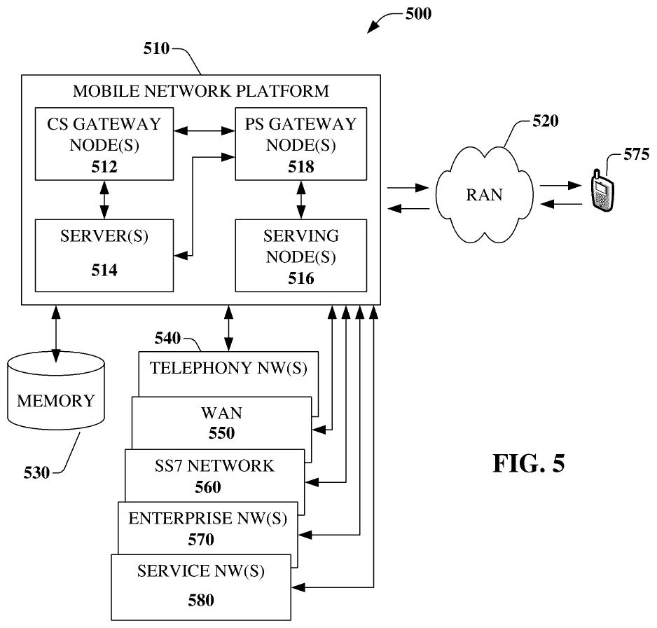

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part systems and methods facilitating user to user authentication and authorization. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology (ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors

configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

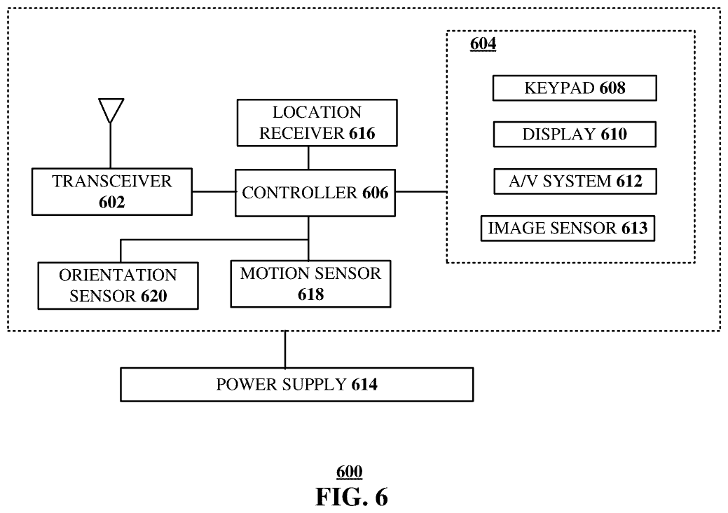

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part systems and methods facilitating user to user authentication and authorization.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VOIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
collecting a set of user information indicative of a user identity, a user device and a usage pattern of the user device, wherein the set of user information is collected to activate wireless communication services with the user device, wherein the user device comprises a primary user device and the primary user device is associated with a primary user;
authenticating the primary user device resulting in an authentication based on the collected set of user information in response to an activation request of an authentication service session from the primary user device;
upon the authentication of the primary user device, receiving an object generated by the primary user device, wherein the received object contains audio visual representation of the primary user and includes audio visual authorization for a secondary user by the primary user;
receiving, from the primary user device, biometric data of the primary user;
matching the received object with an ownership of the primary user device based on the collected set of user information and the biometric data;
upon a confirmation of the matching between the received object and the ownership of the primary user device, storing the received object as a file in a storage; and
generating and transmitting an access mechanism to a stored file to the primary user device.

2. The device of claim 1, wherein the operations further comprise receiving, from the primary user device, a permission to use the set of user information for the authentication service session.

3. The device of claim 1, wherein the operations further comprise, upon the authentication of the primary user device, enabling the primary user to upload an additional form of proof related to the generated object.

4. The device of claim 1, wherein the receiving the object generated by the primary user device further comprises receiving a video stream including video data and audio data of the primary user during the authentication service session.

5. The device of claim 1, wherein the generating the access mechanism further comprise:
generating a link or a QR code to enable the primary user device to access the stored file; and
transmitting the link to a secondary user device to allow the secondary user device to access the stored file, wherein the secondary user device is associated with the secondary user.

6. The device of claim 1, wherein the operations further comprise:
applying a blockchain hash function to the stored file to prevent tampering or a change to the stored file.

7. The device of claim 1, wherein the operations further comprise:
receiving a biometric proof from the primary user device when an authentication check is needed; and
terminating the authentication service session upon failure of the authentication check.

8. A non-transitory machine-readable medium, comprising executable instructions that, when executed by a processing system of a user device including a processor, facilitate performance of operations, the operations comprising:
transmitting a request to generate an authorization object;
receiving a first confirmation that authenticates a user device of a primary user from a service provider system based on at least a set of user information, wherein the set of user information indicative of a user identity, a user device and a usage pattern of the user device is stored in the service provider system to activate wireless communication services with the user device;
upon receiving the first confirmation, generating the authorization object that meets a predetermined standard and contains audio visual representation of the primary user;
receiving a second confirmation that authenticates the authorization object by using a matching between the authorization object and the primary user;
upon receiving the second confirmation, uploading the authorization object to a storage of a trusted server; and
executing an access mechanism to access a stored authorization object on the trusted server.

9. The non-transitory machine-readable medium of claim 8, wherein the operations further comprise transmitting the access mechanism to a secondary user device to facilitate access to the stored authorization object by the secondary user device, wherein the secondary user device is associated with a secondary user.

10. The non-transitory machine-readable medium of claim 8, wherein the generating the authorization object further comprises generating a video stream including the audio visual representation of the primary user and audio visual authorization for a secondary user by the primary user.

11. The non-transitory machine-readable medium of claim 8, wherein the operations further comprises attaching a digital fingerprint and metadata relating to the user device to the generated authorization object.

12. The non-transitory machine-readable medium of claim 11, wherein the operations further comprises providing the service provider system with a face ID, a touch ID, a password or a combination thereof to facilitate the matching between the authorization object and the primary user.

13. The non-transitory machine-readable medium of claim 8, wherein the predetermined standard further comprises a time duration and a size limit of the authorization object, and the audio visual representation of the primary user enables facial and voice matching with previously provided facial data and voice data of the primary user.

14. The non-transitory machine-readable medium of claim 8, wherein the generating the authorization object further comprise generating the authorization object using blockchain smart contracts techniques.

15. A method, comprising:
collecting, by a processing system including a processor, a set of user information indicative of a primary user identity, a primary user device and a usage pattern of the primary user device, wherein the set of user information is collected to activate wireless communication services with the primary user device, wherein the primary user device is associated with a primary user;
authenticating, by the processing system, the primary user device based on the collected set of user information in response to an activation request of an authentication service session from the primary user device;
upon the authentication of the primary user device, receiving, by the processing system, an object generated by the primary user device, wherein the received object contains audio visual representation of a primary user and includes audio visual authorization for a secondary user by the primary user;
receiving, by the processing system, biometric data that authenticate the primary user;
matching, by the processing system, the received object with an ownership of the primary user device based on the collected set of user information and the biometric data;
upon a confirmation of the matching, storing, by the processing system, the received object as a file in a storage; and
generating and transmitting, by the processing system, an access mechanism to a stored file to the primary user.

16. The method of claim 15, further comprising checking, by the processing system, a digital fingerprint and metadata relating to the primary user device attached to the received object.

17. The method of claim 15, wherein the receiving the biometric data further comprises receiving a face ID, a touch ID, a password or a combination thereof to facilitate the matching between the object and the primary user.

18. The method of claim 15, wherein the generating and transmitting the access mechanism further comprises generating and transmitting a link or a QR code to the primary user device, a secondary user device or both, wherein the secondary user device is associated with the secondary user.

19. The method of claim 18, further comprising:
in response to an execution of the link or inputting of the QR code from a secondary user device associated with the secondary user, enabling, by the processing system, the secondary user device to access the stored file in the storage.

20. The method of claim 15, comprising:
upon detection of anomalies, transmitting, by the processing system, an additional authentication request to the primary user device prior to a start of the authentication service session; and
transmitting, by the processing system, a reauthentication request to the primary user device during the authentication service session.
